(19) United States
(12) Patent Application Publication
(10) Pub. No.: US 2006/0179694 A1
(43) Pub. Date: Aug. 17, 2006

(54) Coding identification system and method for drill pipe

(76) Inventor: Charles Thomas Akins, Kilgore, TX (US)

Correspondence Address: Ronald B. Sefrna, P.O. Box 567, Tyler, TX, 75710, US

(21) Appl. No.: 11/342,395

(22) Filed: Jan. 30, 2006

Related U.S. Application Data
(60) Provisional application No. 60/648,598, filed on Jan. 31, 2005.

(51) Int. Cl. B42D 15/00; G09F 3/10

(52) U.S. Cl. 40/299.01; 283/74

(57) ABSTRACT

A system and method of identifying, tracking, and monitoring abrasive wear of an object, including but not limited to drill pipe, exposed to abrasive surface wear includes a thin, preferably circular, disk or plate with identifying indicia, preferably including 2D code and alpha-numeric characters applied to at least the upper face of the plate, with the plate disposed and connected at the bottom of a cavity formed in the object inward from the surface to a depth greater than the thickness of the disk to protect the identifying indicia from abrasive wear. The depth of the cavity is preferably equal to the thickness of the disk plus the predetermined wear limit for the object, so that when the wear limit is indicated when the upper face of the disk becomes flush with the surface of the object.

### RELATED APPLICATION DATA

This application claims the benefit of U.S. Provisional Patent Application Ser. No. 60/648,598, filed Jan. 31, 2005, titled “Coding Identification System For Drill Pipe”.

### FIELD OF THE INVENTION

The present invention generally relates to identification and coding systems, and in its preferred embodiments more specifically relates to a coding system and method for identifying objects subject to surface wear and other extreme conditions, particularly useful for identifying and tracking drill pipes used in the oil and gas industry.

### BACKGROUND

Drill pipe used for drilling, especially, oil and gas wells is exposed to extreme conditions of temperature, pressure, and abrasion. Failure of a drill pipe during “down hole” use can create significant problems for the drilling operation, imposing both delays and recovery expense. Because of the extreme conditions to which it is subjected and the consequences of failure, drill pipe is typically constructed of high grade, costly materials, and the inventory of drill pipe used to drill a typical oil or gas well represents a significant investment. Accordingly, it has become a relatively common practice to mark each unit of drill pipe with an identifying number to allow information about the drill pipe, including location and service life, to be monitored and maintained.

Various approaches to marking drill pipe have been tried and are in use in the industry. In one approach an identifying number is cut or engraved into the surface of the pipe. This approach is reasonably effective so long as the identifying number remains visible. However, because drill pipe is subject to abrasion, the surface of the pipe is worn away during use, and over a period of time the identifying number cut or engraved into the surface of the pipe will disappear. The same problem occurs whether the identifying number is cut into the surface of the pipe or a raised label or tag is attached to the surface of the pipe.

In another approach a small electronic module that can be read with a reader or scanner unit is inserted into a cavity formed in the material of the pipe and sealed into place to protect the electronic module from surface abrasion of the pipe. Although recessing the electronic tags in a closed cavity does effectively protect them from abrasion, they are not protected from the high temperatures and temperature variations to which the drill pipe is subjected, and the failure rate of the electronic tags is high.

The abrasion to which drill pipe is subjected and the resulting erosion of the pipe eventually thins the pipe to the point that it can no longer be used because of the increased risk of failure. Accordingly, drilling operators typically monitor the wear of each section of drill pipe, and retire a section of pipe when the wear reaches a preselected limit. This monitoring is typically done by measuring the diameter of the drill pipe, which requires a worker to manually apply a measuring tool or gauge to the pipe.

It can be understood, then, that there is a need for an effective means of individually marking sections of drill pipe so that each section of pipe can be identified and tracked. There is also a need for a more effective and less labor intensive means of monitoring the degree of wear to individual sections of drill pipe and determining when a section of pipe should be taken out of service.

### SUMMARY OF THE INVENTION

It is among the objects of the invention to provide a system and method for affixing an identification marker to drill pipe and other objects.

It is also among the objects of the invention to provide an identification system for drill pipe and other objects that will withstand high temperatures and pressures without failure.

It is further among the objects of the invention to provide an identification system for drill pipe and other objects that will withstand surface abrasion and wear.

It is still further among the objects of the invention to provide an identification system for drill pipe and other objects that will reliably indicate accumulated wear requiring removal of the pipe from service.

The present invention provides an effective means of marking drill pipe for identification and tracking to accomplish these and other objectives. In the system of the invention a unique code is engraved on the surface of a disk, which is disposed in an open cavity formed in the surface of the drill pipe. The depth of the cavity is greater than the thickness of the disk, so that the upper surface of the disk is recessed below the outer surface of the drill pipe, and is protected from abrasion. The system of the invention can also be used to achieve the objective of monitoring drill pipe for wear and identifying when the wear limit has been reached. When the upper face of the disk is recessed below the surface of the drill pipe to a depth equal to the established wear limit for the pipe, wear of the pipe to the point that the upper surface of the disk is flush with the surface of the pipe is a direct indication that the wear limit has been reached and the pipe should be taken out of service.

The features, structure, and method of the invention will be described in more detail with reference to the accompanying drawing figures.

### BRIEF DESCRIPTION OF THE DRAWINGS

FIG. 1 is a top plan view of the upper face of a preferred embodiment of a marking disk used in the preferred embodiment of the system of the invention.

FIG. 2 is a side elevation, or edge, view of a preferred embodiment of a marking disk used in the preferred embodiment of the system of the invention.

FIG. 3 is an illustrative example of a 2D code marking of the type used in the preferred embodiment of the system of the invention.

FIG. 4 is a top plan view of a preferred embodiment of a marking disk in place in a section of drill pipe.

FIG. 5 is a sectioned side view of a preferred embodiment of a marking disk in place in a section of drill pipe, along line 5-5 in FIG. 4.

FIG. 6 is a sectioned side view of a preferred embodiment of a marking disk in a section of drill pipe, also along line 5-5, when the pipe has worn to the point of required removal from service.

FIG. 7 is a top plan view of an alternative embodiment of a marking disk.

### DESCRIPTION OF THE INVENTION

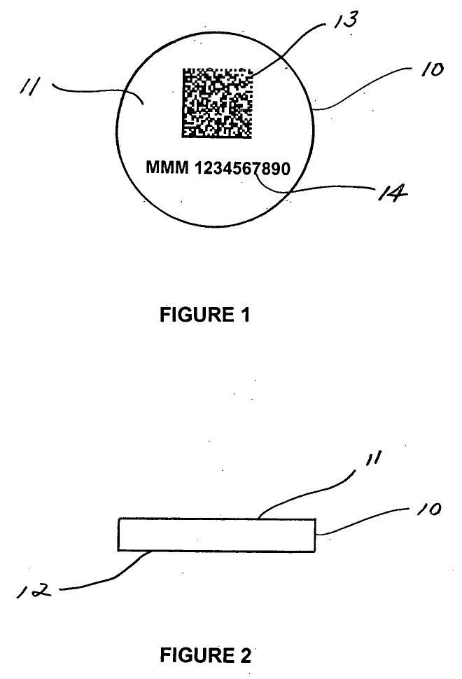

In the preferred embodiment, the system of the invention utilizes a circular disk 10, as shown in FIGS. 1 and 2, having an upper face 11 and a lower face 12, engraved on the upper face with a machine readable code marking 13 and, preferably, also engraved with the identification number 14 for the section of drill pipe in alpha-numeric characters that can be directly perceived and read by a human. Although the use of the alpha-numeric identification number is not essential, it is preferably provided to allow a visual identification of a marked section of drill pipe without scanning the engraved code. In a situation in which a scanner is not available, the alpha-numeric identification number can still be read, and a positive identification of the drill pipe can be made. The inclusion of the alpha-numeric identification number also allows a user to avoid the cost of scanning equipment but still be able to readily identify the drill pipe.

It is also preferred that the code marking 13 and the alpha-numeric identification number 14 also be engraved on lower face 12 of disk 10. Alternatively, the lower face of the disk may be engraved with only the alpha-numeric identification number if desired. When the disk is embedded in a section of drill pipe as described below, the lower face of the disk is fully protected from wear and deterioration, and the code marking and/or alpha-numeric identification number on the lower face are also protected.

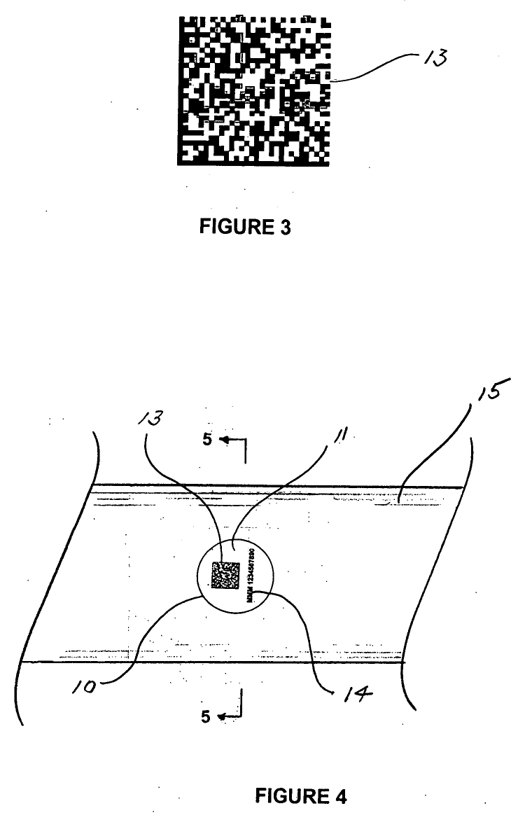

In the preferred embodiment a two dimensional, or 2D, coding is used for the machine readable code marking rather than a one dimensional, or 1D, code such as a simple bar code. An illustrative example of a 2D marking code is shown in FIG. 3. 2D coding has several advantages over traditional 1D coding, including allowing significantly more information or data to be stored in a given area on the disk. For example, a typical 1D bar code is limited to fourteen characters of data, whereas a 2D code can represent up to several hundred characters of data. In the preferred embodiment of the invention, approximately sixty characters of data are stored in the 2D code engraved on the disk. 2D coding also has a distinct advantage over 1D bar code systems in protection of the encoded data. If any part of a traditional 1D bar code is damaged the code marking cannot be scanned. 2D coding systems allow for data redundancy, so that if a portion of the 2D code marking is destroyed the data is available from an undamaged portion of the marking, and the marking can be read by a scanner. The data redundancy allowed by 2D code markings is particularly significant when the coded article, such as a section of drill pipe, is subject to conditions that increase the risk of damage to the code marking.

Although the use of 2D coding in the system of the invention is clearly preferred, it is to be understood that the system of the invention is not limited to that specific coding, and any available type of coding, including but not limited to traditional 1D bar codes, could be used within the scope of the invention.

In the preferred embodiment disk 10 is a planar body formed of 316 stainless steel, although it is to be understood that other suitably durable materials could be used if desired. The disk of the preferred embodiment is approximately one inch in diameter and approximately one tenth of an inch in thickness between the upper and lower faces, although it is also to be understood that other dimensions could be selected and used within the scope of the invention. The code marking 13 and the auxiliary identification number 14, if used, are preferably laser engraved on upper face 11 of the disk. Although other means of applying markings or indicia to the disk could be used, laser engraving is preferred because the markings are cut slightly into the material of the disk rather than applied merely to the surface of the disk, providing improved durability and readability to the code markings. Markings formed by laser engraving are also highly resistant to degradation from chemicals encountered in a typical drilling operation, and are not affected by the high temperatures and pressures to which the drill pipe is subjected during use. The specific placement of the markings on the upper face of the disk is not critical, although it is preferred that the code marking 13 not be disposed at the very edge of the disk. A discrete and unique code is applied to each disk, to uniquely identify each section of drill pipe in which a disk is placed. Each user of the system of the invention may determine the data to be represented by the code marking applied to each disk, and thus to each section of pipe, within the user's discretion. As noted above, the data storage capability of 2D coding allows the storage and retrieval of a significant volume of data, and that capability may be utilized in any desired manner.

In the preferred embodiment of the invention a portion of the data stored in the 2D coding system is a unique serial number or identification number for each section of drill pipe. As noted above, it is also preferred that the identification number also be engraved on the disk in alpha-numeric characters. A comprehensive database may be established and maintained for recording the complete history of a section of drill pipe, accessible by the unique identification number. When the identification number is read from a section of drill pipe the desired information about the drill pipe can then be readily accessed from the database. The data storage capability of the 2D coding system also allows information about a section of drill pipe to be stored directly on the drill pipe so that it is immediately available from a scanner read-out without connection to, e.g., a remotely maintained database.

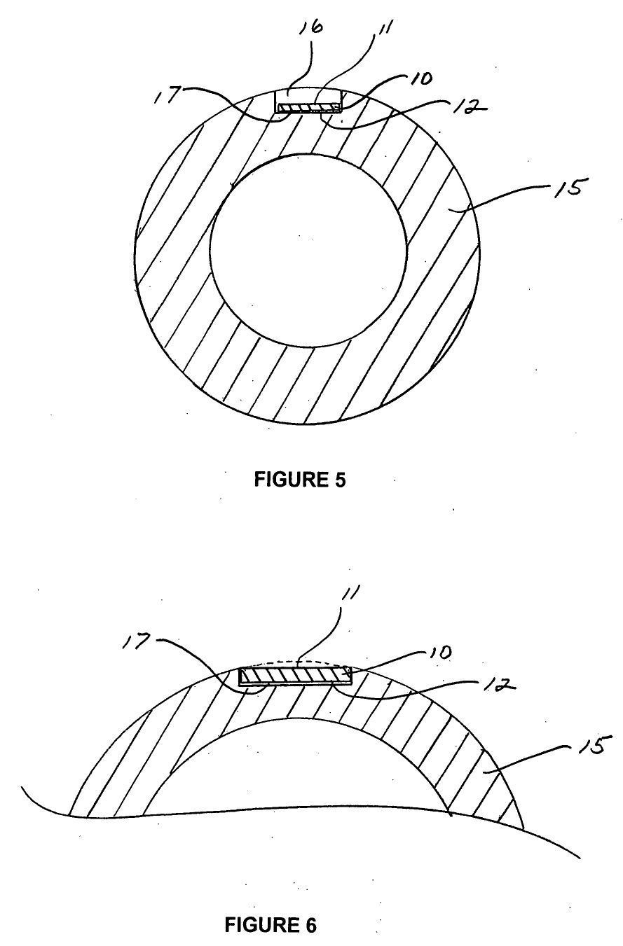

As generally illustrated in FIGS. 4 and 5, each engraved disk is associated with a section of drill pipe 15 by embedding the disk within a cavity 16 extending toward the interior of the drill pipe from the outer surface thereof. As shown in FIG. 5, the depth of cavity 16 is greater than the thickness of disk 10, so that the disk is countersunk within the cavity. The disposition of the upper face 11 of the disk below the outer surface of the pipe protects the marked face of the disk from abrasion and erosion, and assures the continued readability of the code markings over the useful life 20 of the section of drill pipe. The disk is securely connected within the cavity by means of, for example, an adhesive material 17 disposed between the bottom of the cavity and the lower face 12 of the disk. Alternatively, other means of securing the disk in the cavity may be used if desired, so long as the code markings are not obscured. It is preferred that the disk be removable from the cavity. In the unlikely event that the markings on the upper face of the disk are damaged so as to become unreadable, the disk may be removed from cavity 16 and the protected markings on the lower face of the disk can be read. A replacement disk may then be secured in cavity 16 to assure continued tracking of the section of drill pipe.

In the preferred embodiment cavity 16 is left open above the upper face of disk 10. Although some debris may accumulate in the cavity during use of the drill pipe, any accumulated debris is easily removed for scanning the code marking engraved on the disk, and the presence of debris may actually serve to protect the face of the disk. Although not preferred, cavity 16 may be filled above the disk with, e.g., a transparent material or a removable plug, if desired. It is contemplated, however, that since any filler material placed in the cavity, even though initially transparent, is subject to the same abrasion and erosion as the drill pipe, it is likely to become scratched to an extent that the code marking on the upper face of the disk is obscured and cannot be scanned without removing the filler material.

Boring the small cavity 16 in a section of drill pipe will not compromise the strength or durability of the pipe or reduce its utility. The location of the cavity is subject to some variation and is within the discretion of the user or manufacturer, but should be disposed in a location subject to wear and erosion in order to take full advantage of the features of the system of the invention. It is contemplated that cavity 16 will typically be disposed in a collar or tool joint.

In addition to providing a secure and protected code marker, the system of the invention may, in appropriate circumstances, also provide a simple and reliable means of monitoring the wear experienced by a section of drill pipe, and determining when the wear has reached the point at which the drill pipe must be removed from service. During use, the surface of a drill pipe is abraded away, and when the diameter of the monitored area of the pipe is reduced to a predetermined dimension the section of pipe may no longer be used.

When the structure of a section of drill pipe is such that cavity 16 may safely be bored to a depth equal to the thickness of disk 10 plus the wear allowance for that section of drill pipe, the distance between the surface of the pipe and the upper face 11 of the disk is accordingly equal to the wear allowance for the pipe. During the use of the pipe section that distance will gradually decrease as the pipe wears and the diameter of the pipe decreases, until the pipe is worn down to the edges of the face of the disk, as shown in FIG. 6. Because the cross-sectional configuration of the pipe is circular, and the face of the disk is flat, erosion of the pipe will expose the edges of the disk before the inner portion of the face of the disk is exposed to abrasion. Therefore, the code marking disposed on the inner portion of the upper face of the disk will remain readable when the pipe has worn to the point at which it must be removed from service. With the system of the invention, monitoring the wear of drill pipe may be reliably performed visually, without the need to measure the diameter of the pipe.

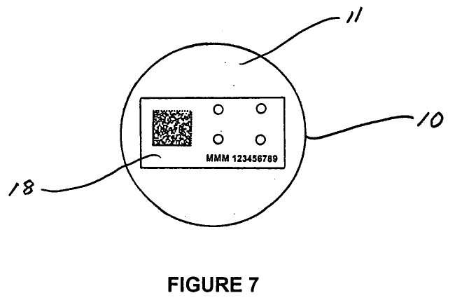

The system of the invention is subject to a number of variations and alternative embodiments within the scope of the invention. In one variation, though not preferred, the code markings could be omitted from the lower face 12 of disk 10. In another variation or alternative embodiment, identifying indicia such as code marking 13 may be engraved, or otherwise formed or applied to, a thin, preferably metal, tag 18, which is attached to the upper face 11 of the disk, as illustrated in FIG. 7.

A circular configuration for cavity 16, and the corresponding use of circular disks 10, is preferred, because a circular cavity may be more easily bored in a drill pipe and is more easily cleaned for scanning the code marking, and because the circular configuration minimizes structural stress on the drill pipe. However, it is to be understood that the scope of the invention encompasses the use of non-circular cavities and non-circular marking plates. Accordingly, configurations such as, but not limited to rectangular marking plates cavities may be utilized, and the use of the term “disk” in the foregoing description is to be understood to include non-circular configurations.

It is also to be understood that although the system of the invention is particularly useful in the context of identifying, tracking, and monitoring drill pipe, the invention may be effectively utilized for identifying, tracking, and/or monitoring the condition of any items or components. The system of the invention is particularly advantageous for use with any equipment or component that is subject to ablative wear and/or extreme environments.

The foregoing description of the preferred and alternative embodiments, and variations of the system of the invention is intended to be illustrative and not limiting. Further variations and alternative embodiments may be devised by those skilled in the art on the basis of the foregoing description and within the scope of the invention in accordance with the following claims.

1. An identification system for marking objects having an outer surface, comprising
a thin plate having an upper face, a lower face, and a perimeter edge, said upper face including identifying indicia formed thereon; and
an open cavity formed in the outer surface of the object to be identified, the configuration of said cavity matching the configuration of said perimeter edge of said plate, said cavity extending into the object from the outer surface thereof a distance greater than the distance between said upper face and said lower face of said plate, said plate connected within said cavity with said upper face of said plate disposed below the outer surface of the object to be identified.

2. The identification system of claim 1, wherein said perimeter edge of said plate is circular, and wherein said configuration of said cavity is circular.

3. The identification system of claim 1, wherein both said upper face and said lower face of said plate include identifying indicia formed thereon.

4. The identification system of claim 1, wherein said identifying indicia is engraved into said upper face of said plate such that said identifying indicia is recessed below said upper face of said plate.

5. The identification system of claim 3, wherein said identifying indicia is engraved into said upper face of said plate such that said identifying indicia is recessed in said upper face of said plate, and is engraved into said lower face of said plate such that said identifying indicia is recessed in said lower face of said plate.

6. The identification system of claim 1, wherein said identifying indicia includes a machine readable code.

7. The identification system of claim 6, wherein said code is a 2D code.

8. The identification system of claim 6, wherein said identifying indicia further includes alpha-numeric characters.

9. The identification system of claim 1, wherein said identifying indicia is formed on a thin tag plate and said tag plate is connected to said upper face of said plate, and wherein said tag plate is disposed below the outer surface of the object to be identified.

10. The identification system of claim 1, wherein said plate is formed of stainless steel.

11. The identification system of claim 3, wherein said plate is removably connected within said cavity.

12. A method of affixing identifying indicia to an object having an outer surface, such indicia including information for identifying and tracking the object, comprising the steps of
forming a thin plate having an upper face, a lower face, a thickness between said upper face and said lower face, and a perimeter edge;
applying identifying indicia to said upper face of said plate;
forming a cavity in the object to which identifying indicia is to be affixed, said cavity having an open top and a closed bottom, said cavity extending inward from the outer surface of the object into the object a depth greater than said thickness of said plate;
connecting said plate within said cavity at said bottom of said cavity, with said upper face of said plate facing said open top of said cavity such that said identifying indicia applied to said upper face of said plate is accessible through said open top of said cavity, and with said upper face of said plate disposed in said cavity below the outer surface of the object surrounding said cavity.

13. The method of claim 12, wherein said plate is removably connected within said cavity, and comprising the additional step of applying identifying indicia to said lower face of said plate prior to connecting said plate within said cavity.

14. The method of claim 12, wherein said identifying indicia is applied to upper face of said plate by engraving said identifying indicia into said upper face of said plate.

15. The method of claim 13, wherein said identifying indicia is applied to said upper face of said plate by laser engraving, and wherein said identifying indicia is applied to said lower face of said plate by laser engraving.

16. The method of claim 12, wherein said identifying indicia is applied to said upper face of said plate by engraving said identifying indicia on an indicia tag and connecting said indicia tag to said upper face of said plate.

17. A method of identifying, tracking, and monitoring wear of an object subject to abrasive wear abrading away the object from the surface of the object inward, and determining when abrasive wear has reached a predetermined limit, comprising the steps of
forming a thin plate having an upper face, a lower face, a thickness between said upper face and said lower face, and a perimeter edge;
applying indicia to said upper face of said plate for the purpose of uniquely identifying the object and including any desired predetermined tracking information;
forming a cavity in the object, said cavity having an open top and a closed bottom, said cavity extending inward from the outer surface of the object into the object a depth equal to said thickness of said plate plus the predetermined limit of abrasive wear for the object;
connecting said plate within said cavity at said bottom of said cavity, with said upper face of said plate facing said open top of said cavity such that said identifying indicia applied to said upper face of said plate is accessible through said open top of said cavity, and with said upper face of said plate disposed in said cavity at a depth below the outer surface of the object surrounding said cavity equal to the predetermined limit of abrasive wear;
reading said indicia applied to said upper face of said plate from time to time during use or service of the object for the purpose of identifying the object and extracting tracking information included in the indicia; and
inspecting the remaining depth of said cavity between the surface of the object and said upper face of said plate from time to time to determine the degree of abrasive wear of the object, until said upper face of said plate is flush with the surface of the object, thereby indicating that the predetermined limit of abrasive wear has been reached.

18. The method of claim 17, comprising the additional step of applying indicia to said lower face of said plate for the purpose of uniquely identifying the object and including any desired predetermined tracking information, and wherein said plate is removably connected within said cavity.

19. The method of claim 17, wherein said indicia is applied to said upper face of said plate by engraving.

20. The method of claim 17, wherein said indicia includes machine readable 2D coding.
